(19) United States
(12) Patent Application Publication
(10) Pub. No.: US 2005/0263475 A1
(43) Pub. Date: Dec. 1, 2005

(54) Convenience system for handling of baby bottles

(76) Inventors: Beth Carlson, Delray Beach, FL (US); Faith Gingras, Delray Beach, FL (US)

Correspondence Address: Mark D. Bowen;Stearns Weaver Miller, Suite 1900, 200 East Broward Boulevard, Fort Lauderdale, FL, 33301, US

(21) Appl. No.: 10/857,511

(22) Filed: May 28, 2004

(51) Int. Cl. A61J 9/08; A61J 11/00; A61J 9/00

(52) U.S. Cl. 215/11.1; 215/11.6

(57) ABSTRACT

A convenience system for baby bottles that provides a bottle structure adapted for containing water and a pre-measured quantity of powdered formula in separate internal compartments prior to use. The specially adapted bottles thus allow for suitable quantities of water and powdered formula to be separately contained within the bottle structure, and easily mixed within the bottle just prior to feeding. A carrying system adapted with a handle is provided for carrying a plurality of bottles thereby maximizing convenience.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates generally to feeding bottles for infants and small children, and more specifically to a convenience system for infant feeding bottles including a carrying apparatus and specially configured feeding bottles that are adapted for convenient mixing of internally separately stored formula and water.

2. Description of Related Art

The use of infant feeding bottles, commonly referred to as baby bottles, to feed infants specially prepared feeding formulations is well known. Conventional baby bottles include a glass or plastic container having an externally threaded container opening, a feeding nipple, and a screw-on top for securing the nipple to the container. Both the container and the nipple are reusable, however, disposable versions are also known. A standard feeding nipple is commonly made of either natural or synthetic rubber, both of which are flexible and compressible. Standard nipples are available for premature infants, newborns, and toddlers. An opening in the tip end of the nipple permits liquid to be withdrawn from the container in response to a sucking action by the nursing infant.

It is common to prepare feeding formulations by mixing water with commercially available substances, such as concentrated liquid or powder formula. This typically requires ready access to a source of filtered water and the necessary formulation. While such access to the formula and water is readily available in the home, such is not the case when the care giver is away from the home with the infant as often occurs in today's mobile society. Dilution water, and ordinary tap water in particular, may contain trace amounts of minerals or bacteria that is harmful to infants. Chlorination of drinking water, although common throughout most of the United States, is not universal. Water systems in remote locations often lack the chlorine residual necessary to sanitize the water for drinking purposes. In addition, the care giver must carry separately packaged formula for mixing with the water. This necessitates carrying separate containers, as well as measuring and mixing steps that further complicate the process. The process is further complicated when multiple bottles must be prepared while away from home. As should be apparent, the preparation of the feeding formulations while away from home can be difficult and cumbersome.

Accordingly, there exists a need for an infant feeding system that overcomes the disadvantages present in the art by providing an improved infant feeding system adapted for containing both water and formula in separate internal compartments, thereby eliminating the need for finding a suitable source of water while also eliminating the need for carrying separate containers of formula. There further exists a need for such a system wherein a plurality of bottles can be conveniently carried.

### BRIEF SUMMARY OF THE INVENTION

The present invention provides a convenience system for baby bottles that provides a bottle structure adapted for containing water and pre-measured formula in separate internal compartments prior to use. The specially adapted bottles thus allow for suitable quantities of water and powdered formula to be separately contained within the bottle structure, and easily mixed within the bottle just prior to feeding. A carrying system adapted with a handle is provided for carrying a plurality of bottles thereby maximizing convenience.

Accordingly, it is an object of the present invention to provide an improved feeding bottle capable of storing water and pre-measured formula in separate sterile compartments.

Another object of the present invention is to provide a bottle holder adapted to carry a plurality of feeding bottles.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a perspective view of a feeding bottle in accordance with the present invention with the top portion removed;

FIG. 2 is an exploded perspective view of an improved feeding bottle in accordance with the present invention;

FIG. 3 is a perspective view thereof;

FIG. 4 is a perspective view thereof in partial section;

FIG. 5 is a perspective view of a formula-storing container housed within an infant feeding bottle in accordance with the present invention;

FIG. 6 is an exploded perspective view depicting the formula-storing container in relation to the infant feeding bottle;

FIG. 7 is a perspective view of an alternate embodiment infant feeding system in accordance with the present invention;

FIGS. 8 and 9 are partially exploded perspective views thereof;

FIG. 10 is an exploded perspective view of the formula-storing cap thereof;

FIG. 11 is a sectional view of the formula-storing cap;

FIG. 12 is a side elevational view of yet another alternate embodiment infant feeding bottle in accordance with the present invention;

FIG. 13 is an exploded perspective view thereof;

FIG. 14 is a perspective view thereof in partial section; and

FIGS. 15-17 depict a carrying apparatus adapted for use with infant feeding bottles according to the present invention.

### DETAILED DESCRIPTION OF THE INVENTION

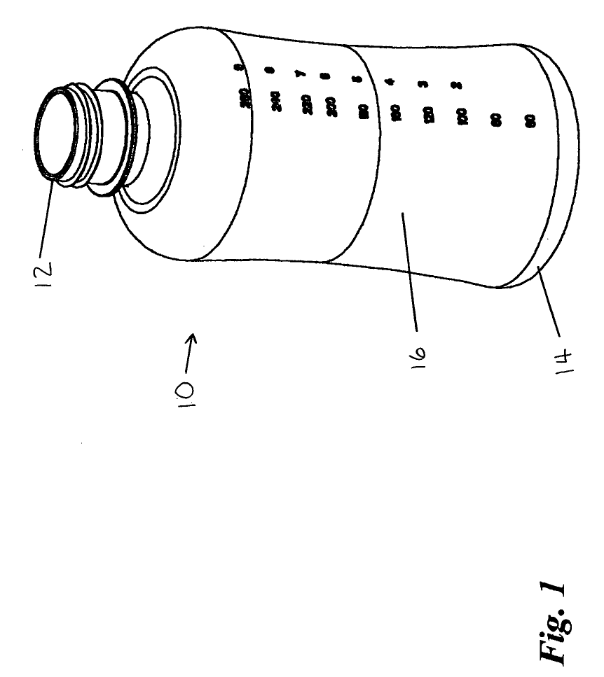

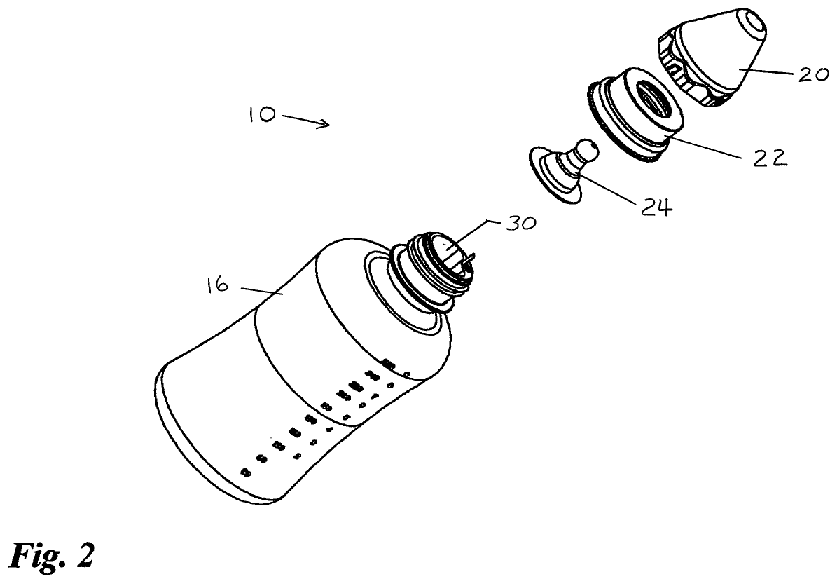

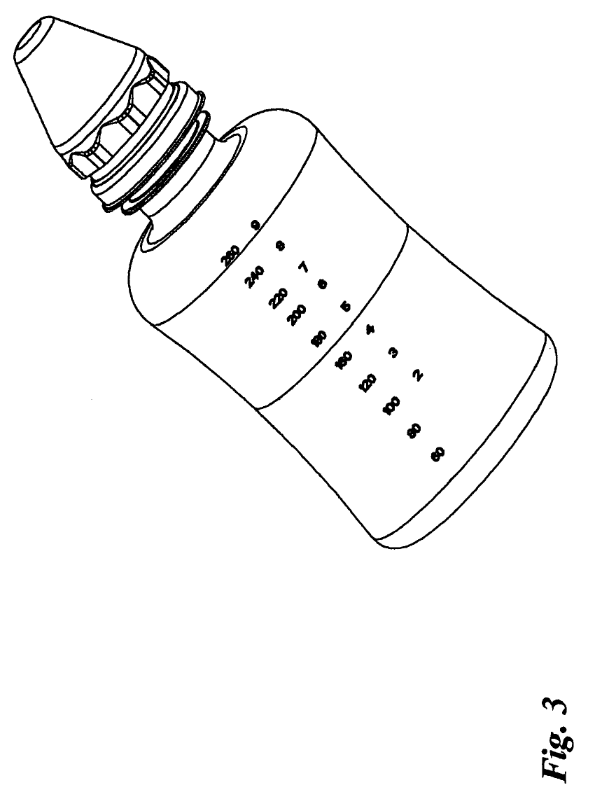

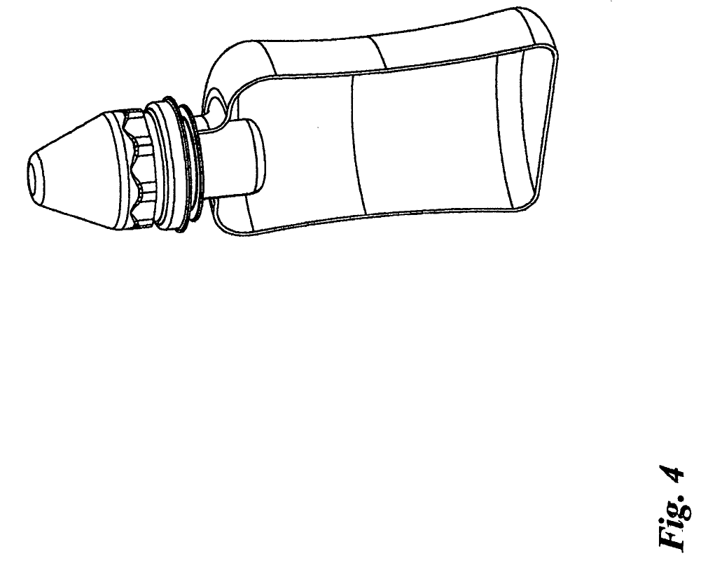

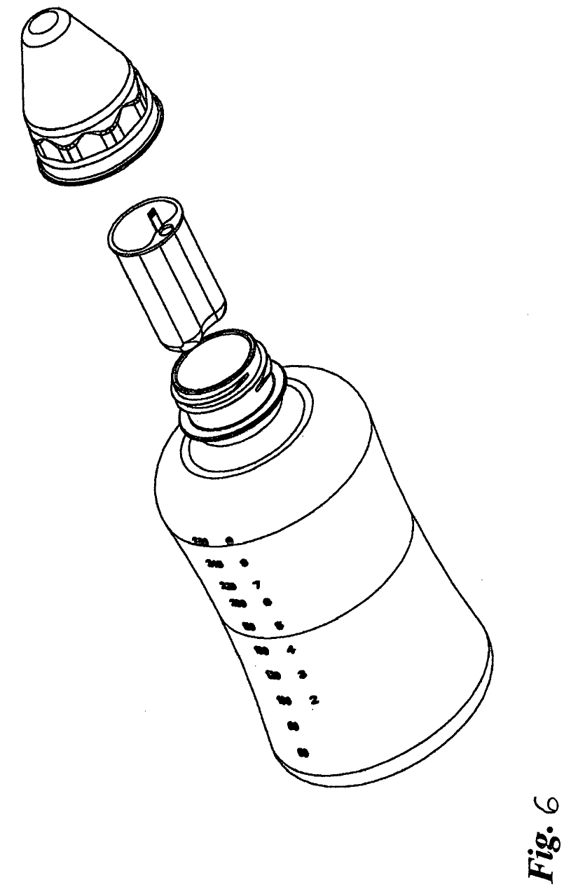

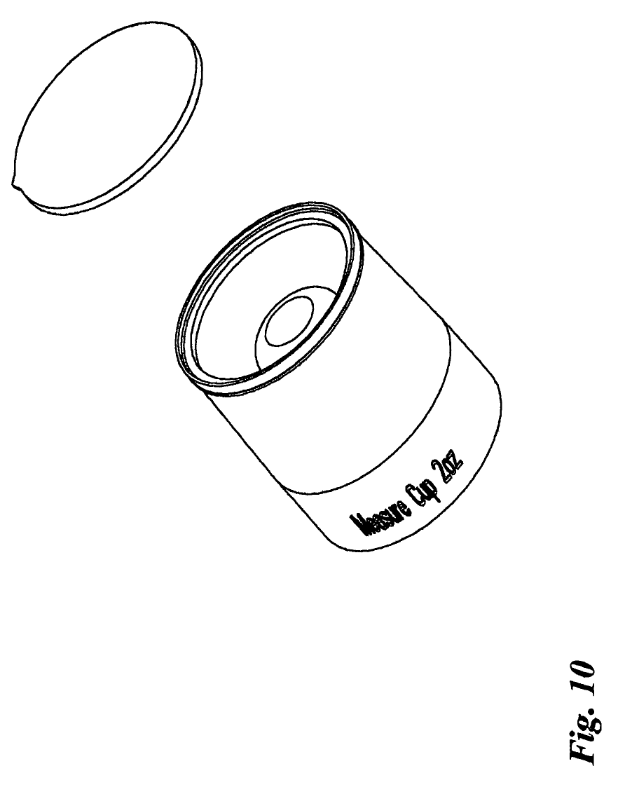

With reference now to the drawings, FIGS. 1-17 depict an improved infant feeding system according to the present invention. FIGS. 1-6 depict a preferred embodiment of an improved infant feeding bottle according to the present invention, generally referenced as 10. Infant feeding bottle 10 comprises a generally cylindrical container having an externally threaded top 12, a bottom 14, and a side wall 16. Infant feeding bottle 10 may be fabricated from plastic, or any other suitable material. In embodiments wherein infant feeding bottle 10 is to be disposable, the container may be fabricated from polyethylene or polypropylene. As best depicted in FIG. 2, infant feeding bottle 10 preferably includes a cap 20, an internally threaded ring 22, a nipple 24, and receptacle 30 for storing formula. Cap 20, ring 22, and nipple 24 connect to the top 12 of bottle 10 in the configuration depicted in FIG. 2, in a generally conventional manner.

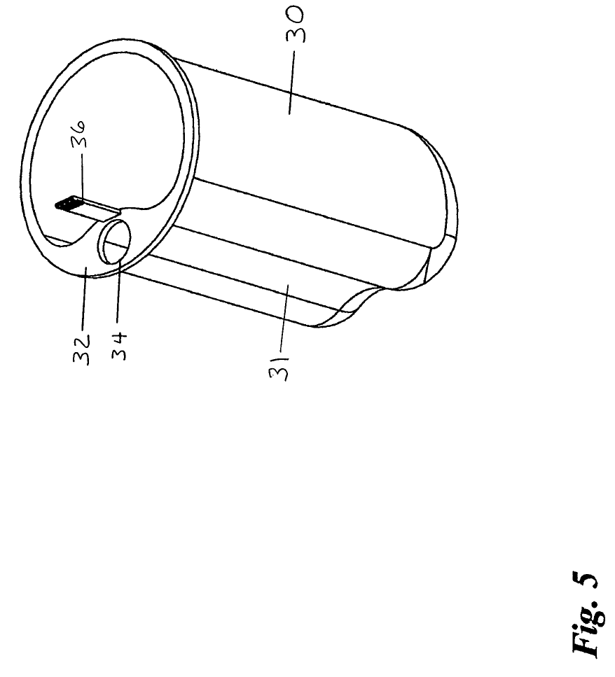

As best depicted in FIG. 5, receptacle 30 comprises a cup-like body that functions as a temporary storage receptacle for feeding formula, such as powdered formula prior to mixing with water stored in the main body of bottle 10. Receptacle 30 includes a radially projecting upper peripheral lip 32 that functions as a stop by engaging the top 12 of bottle 10 to prevent receptacle 30 from sliding completely into bottle 10. Receptacle 30 is semi-cylindrical and includes a concave portion, referenced as 31, to prevent receptacle 30 from completely filling the opening formed at the top 12 of bottle 10. Peripheral lip 32 defines an aperture 34 that will allow feeding formula to pass from the interior of bottle 10 into the nipple attachment 24 when receptacle 30 is disposed within the top 12 of bottle 10. Receptacle 30 further includes an upwardly projecting tab 36 that functions as a grasping structure to facilitate insertion and removal of receptacle 30 to/from the top 12 of bottle 10.

Receptacle 30 functions as a temporary storage receptacle preferably for powdered formula prior to mixing. More particularly, a care giver may fill bottle 10 with a suitable quantity of filtered water, deposit a pre-measured quantity of powdered formula into receptacle 30, then insert receptacle 30 into the neck formed at the top 12 of bottle 10, and secure and cap the bottle with nipple 24, ring 22, and cap 20. Receptacle 30 thus functions to contain the powdered formula in a dry compartment during transport. Once the care giver desires to feed an infant, cap 20, ring 22, and nipple 24 are simply removed. Next, the user removes receptacle 30 by grasping tab 36 and pours the powdered formula contained within receptacle 30 into bottle 10. Thereafter, receptacle 30 may be reinserted into the top 12 of bottle 10, and the bottle may be capped with nipple 24, ring 22, and cap 20 in an otherwise conventional manner. The formula may be mixed by shaking the bottle prior to use. When bottle 10 is inverted in a position for feeding, the liquid formula is fed to the infant by passing through receptacle aperture 34 and nipple 22.

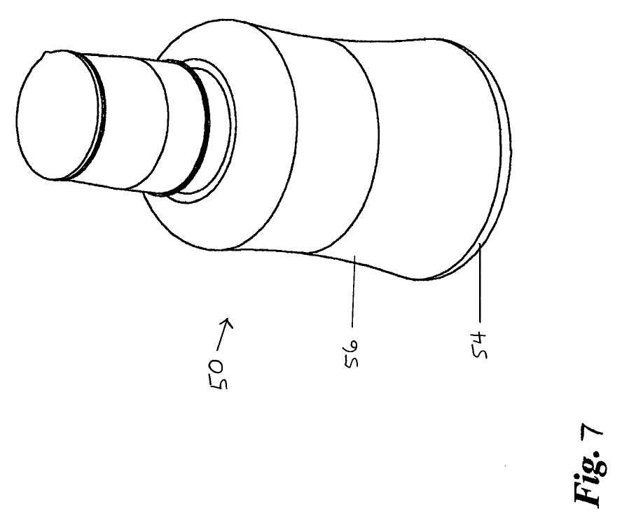

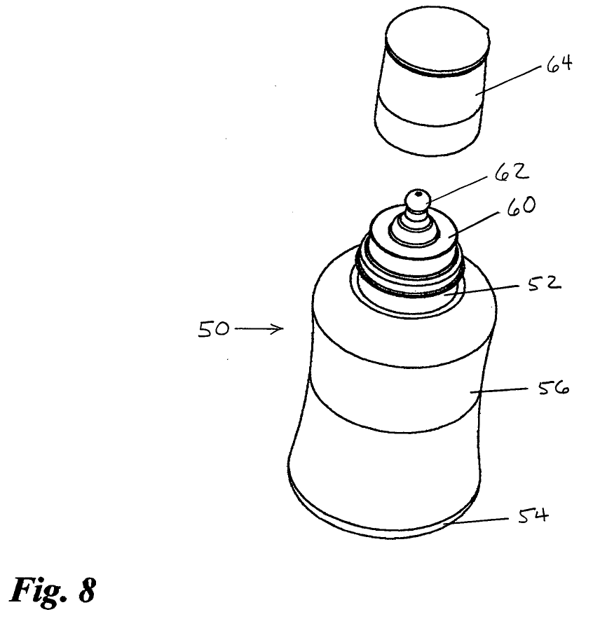

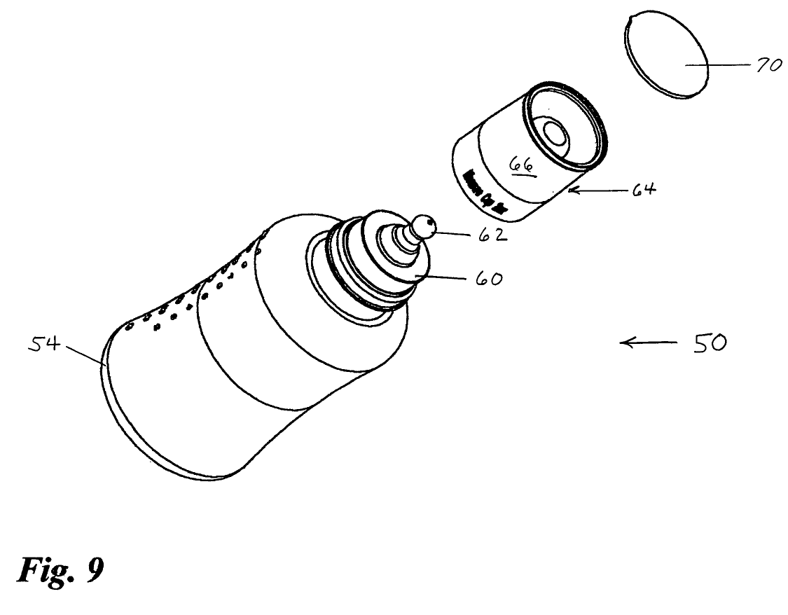

FIGS. 7-11 depict an alternate embodiment infant feeding bottle, generally referenced as 50, in accordance with the present invention. Infant feeding bottle 50 comprises a generally cylindrical container having a top 52, a bottom 54, and a side wall 56. Infant feeding bottle 50 may be fabricated from plastic, or any other suitable material. In embodiments wherein infant feeding bottle 50 is to be disposable, the container may be fabricated from polyethylene or polypropylene. As best depicted in FIGS. 8 and 9, infant feeding bottle 50 preferably includes a threaded ring 60 securing a replaceable nipple 62 to the top 52 of bottle 50. Bottle 50 further includes a cap, generally referenced as 64, adapted for removable engagement with the top 52 of bottle 50 so as to be in removable covering relation with nipple 62 and threaded ring 60 as depicted in FIG. 7.

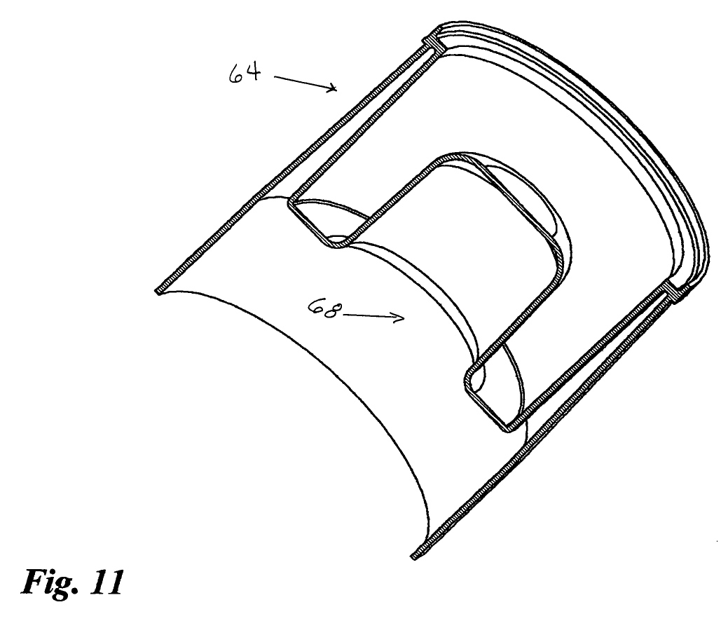

Cap 64 comprises a generally cylindrical cap defining an interior chamber defined by a side wall 66, a concave bottom 68, and an openable top 70. As best depicted in FIG. 11, cap 64 defines an interior chamber that functions as a temporary storage chamber for dry powdered formula. Top 70 is structured so as to receive openable top 70 removably thereon. Concave bottom 68 defines a recessed area for receiving nipple 62 therein when cap 64 is placed on the top 52 of bottle 50.

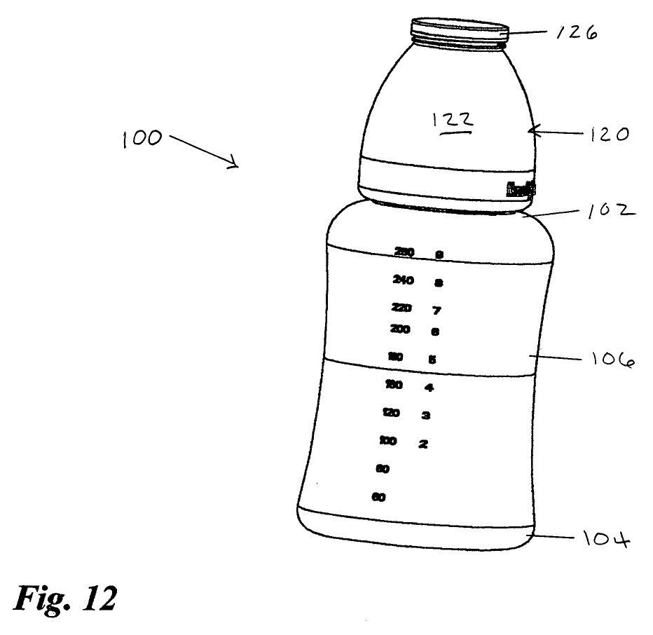

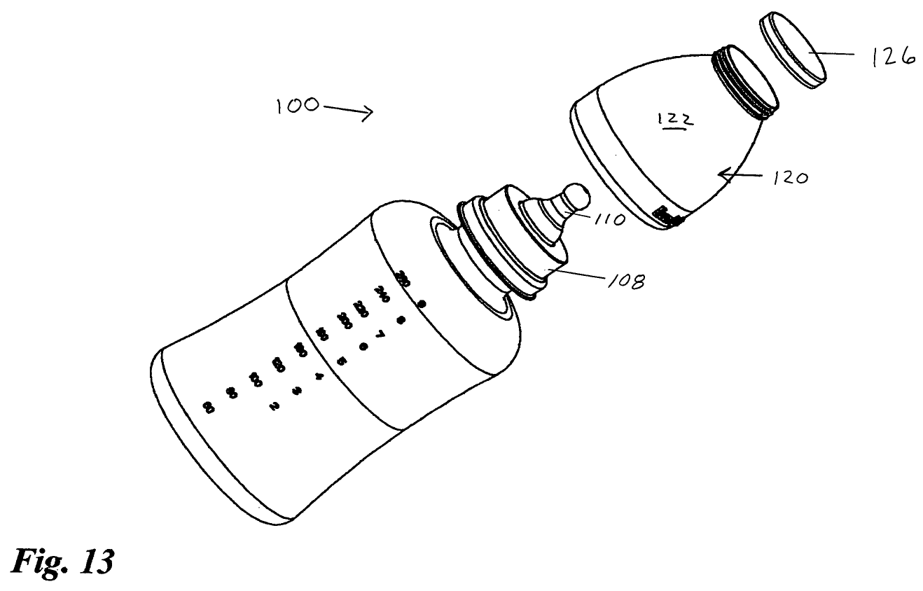

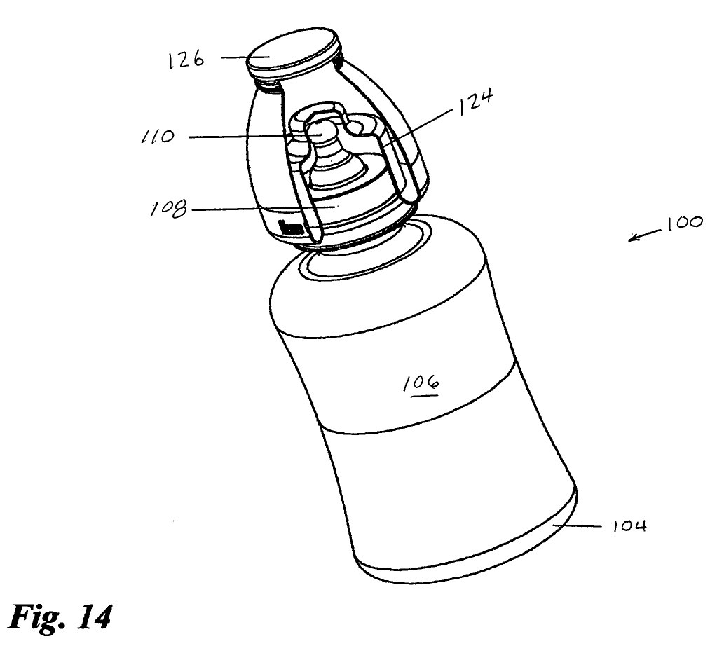

FIGS. 12-14 depict yet another alternate embodiment infant feeding bottle, generally referenced as 100, in accordance with the present invention. Infant feeding bottle 100 comprises a generally cylindrical container having a top 102, a bottom 104, and a side wall 106. Infant feeding bottle 100 may be fabricated from plastic, or any other suitable material. In embodiments wherein infant feeding bottle 100 is to be disposable, the container may be fabricated from polyethylene or polypropylene. As best depicted in FIGS. 13 and 14, infant feeding bottle 100 preferably includes a threaded ring 108 securing a replaceable nipple 110 to the top 102 of bottle 100. Bottle 100 further includes a cap, generally referenced as 120, adapted for removable engagement with the top 102 of bottle 100 so as to be in removable covering relation with nipple 110 and threaded ring 108 as depicted in FIG. 14.

Cap 120 comprises a generally hollow structure defining an interior chamber defined by a side wall 122, a concave bottom 124, and an openable top 126. As best depicted in FIG. 13, cap 120 preferably includes an openable top 126 adapted for mating threaded engagement with cap 120. It should be noted, however, that any suitable openable structure is considered within the scope of the present invention. As best depicted in the sectional view of FIG. 14, cap 100 defines an interior chamber that functions as a temporary storage chamber for dry powdered formula. Bottle top 102, and more particularly, threaded ring 108, is structured so as to receive openable top 120 removably thereon. The mating connection between top 120 and either bottle 102 or threaded ring 108, may be by press fit, by continuous bead, or by threaded connection, all of which are known in the art of connecting components. As with the previous embodiment, concave bottom 124 defines a recessed area for receiving nipple 110 therein when cap 120 is placed on bottle 100.

As should be apparent, the various embodiments of infant feeding bottles disclosed herein are particularly adapted for allowing the care giver to fill the bottle with a suitable quantity of water while storing powdered infant formula in a dry compartment until use is desired. The infant feeding bottles disclosed herein thus provide containers specially adapted for transport, and are particularly suited for use by care givers while away from home.

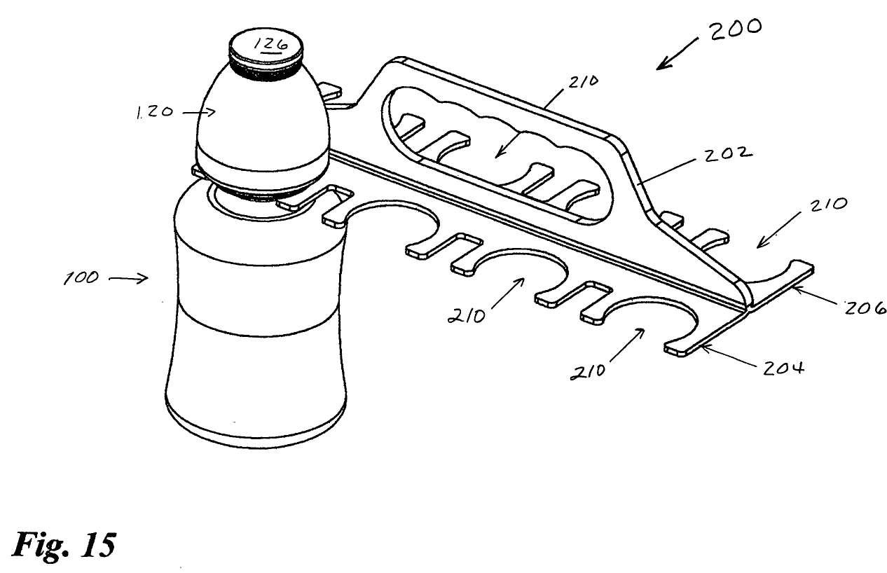

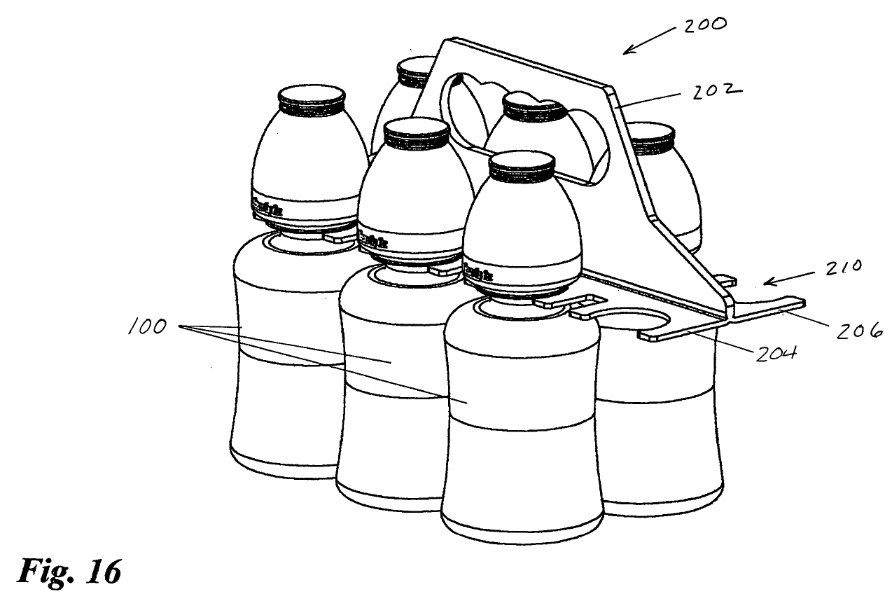

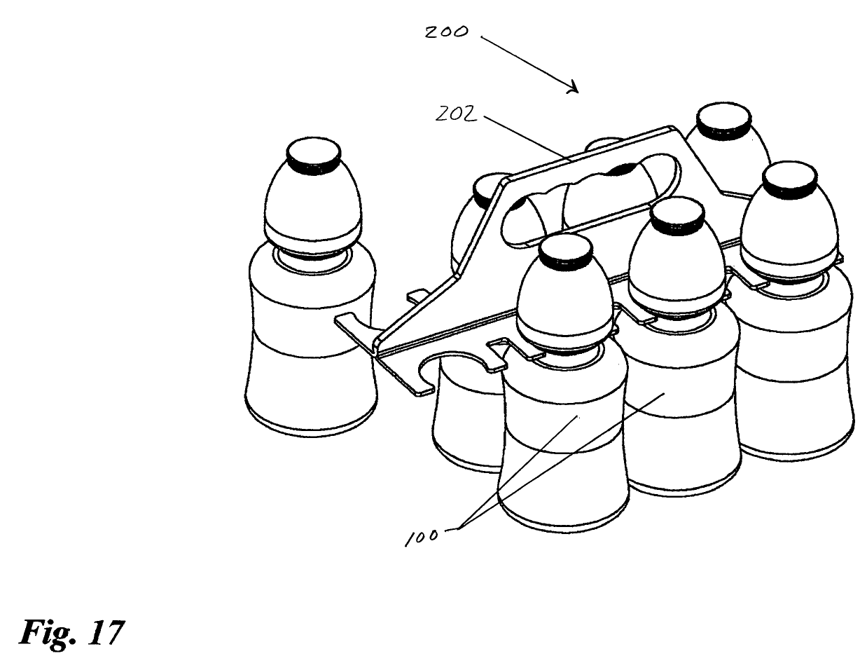

FIGS. 15-17 depict a carrying apparatus 200 for use in conveniently carrying a plurality of bottles of the type disclosed herein. Carrying apparatus 200 preferably includes a handle portion 202, and opposing left and right side plates, referenced as 204 and 206 respectively, projecting laterally from handle portion 202. Each left and right side plate defines a plurality of cut-outs, referenced as 210, each of which are suitably sized and shaped for press fit mating engagement with the top portion 102 of an infant feeding bottle 100 as best depicted in FIG. 15. As should be apparent, a plurality of bottles may be conveniently attached and carried using carrying apparatus 100. More particularly, as best illustrated in FIGS. 16 and 17, a total of eight infant feeding bottles, referenced as 100, may be attached and hand carried using handle 202.

The instant invention has been shown and described herein in what is considered to be the most practical and preferred embodiment. It is recognized, however, that departures may be made therefrom within the scope of the invention and that obvious modifications will occur to a person skilled in the art.

1. An infant feeding system comprising:
a bottle body for containing liquid, said body defining a chamber and an open top;
a rubber nipple adapted for mating engagement with said open top;
a ring, attachable to said open top, for securing said rubber nipple to said open top;
a cap adapted for removable attachment to said ring in covering relation with said rubber nipple; and
compartment means for temporarily storing infant feeding formula separate from said body chamber, whereby infant feeding formula may be selectively mixed with a liquid in said bottle body chamber.

2. An infant feeding system according to claim 1, wherein said compartment means comprises a cup adapted for removable insertion within said body open top.

3. An infant feeding system according to claim 1, wherein said compartment means comprises a volume defined within said cap, said cap adapted with an openable top.

4. An infant feeding system including a bottle adapted for storing water and infant feeding formula in separate compartments prior to feeding, said infant feeding system comprising:
a bottle body for containing liquid, said body defining a internal chamber and an open top communicating with said internal chamber;
a rubber nipple adapted for mating engagement with said open top;
a ring, attachable to said open top, for securing said rubber nipple to said open top;
a cap adapted for removable attachment in covering relation with said rubber nipple, said cap defining an internal, watertight compartment sealed with an openable closure for temporarily storing infant feeding formula separate from said body chamber.

5. An infant feeding system according to claim 4, further including a carrying apparatus, said carrying apparatus including a handle and opposing left and right projecting structures connected to said handle, each of said projecting structures adapted for attachment to at least one bottle.

6. An infant feeding system according to claim 4, wherein said cap includes a outer bottom surface defining a concave recessed portion for receiving at least a portion of said rubber nipple when said cap is attached in covering relation with said nipple.
